(19) United States
(12) Patent Application Publication
(10) Pub. No.: US 2012/0143991 A1
(43) Pub. Date: Jun. 7, 2012

(54) SYSTEM, METHOD AND SOFTWARE APPLICATION FOR THE CONTROL OF FILE TRANSFER

(76) Inventors: Anthony Eugene Collins, New South Wales (AU); Judit Kay, New South Wales (AU)

(21) Appl. No.: 13/381,264

(22) PCT Filed: Jun. 30, 2010
(86) PCT No.: PCT/AU10/00823

§ 371 Date: Feb. 22, 2012

(30) Foreign Application Priority Data
Jun. 30, 2009 (AU) 2009903040

(51) Int. Cl. G06F 15/16

(52) U.S. Cl. 709/217

(57) ABSTRACT

A method for transferring files to a pervasive computing system, comprising the steps of selecting on a computing system, via a portable computing device, at least one file to be made available to a pervasive computing system, and allowing the selected files to be transferred from a computing system to the pervasive computing system.

### FIELD OF THE INVENTION

The present invention relates to a system, method and software application for the control of file transfer across a plurality of computing systems. The invention finds particular, but not exclusive use in the area of pervasive computing (such as surface or tabletop computing).

### BACKGROUND OF THE INVENTION

In recent times, there has been a strong trend towards “pervasive” or “interactive” computing interfaces. At a broad level, pervasive or interactive computing interfaces are interfaces which allow a group of users to collaborate and work together, commonly through a single interface, such as a tabletop.

One example of a pervasive computing system is a “tabletop” or “surface” computing system. This is a computing system where the interface is displayed on a surface (vertical or horizontal), allowing users to interact with the computing system by interacting with the tabletop. It will be understood that from hereonin, the term “tabletop computer” will be utilized as a generic term to describe pervasive surface computing systems and should not be taken to be a limiting term.

Tabletop computing systems strive to provide more natural and intuitive ways for users to interact with computing systems and the information contained therein and moreover, provide a system where users can participate in collocated, collaborative work.

New interactive tabletops are being designed to complement a user's increasingly sophisticated carried devices, such as smart phones, as well as other portable devices such as laptops. Of particular importance is a mechanism for enabling users to use interactive surfaces to access and work with their own collections of files, particularly when collaborating with others in a collocated setting.

However, even if we ignore the issues raised by interactive surface computing, users already have trouble finding digital information, particularly when it is scattered across different computers and devices. This problem will only become worse as users gain access to increased storage capacities and acquire more computing devices.

The hierarchical file system, which has hardly changed from a user's perspective since it was first introduced in the 1970s, is deeply entrenched in many users' mental models of how to store and retrieve files. Consequently, new file system access mechanisms face the challenge that users will initially find them unfamiliar, and possibly unpredictable, if they do not involve retrieving files from a hierarchical location already known to the user.

In other words, for new file systems to be useful, intuitive and attractive, users must retain some understanding and control over their own personal file system, particularly in a tabletop computing environment. As each user's file system is unique in terms of both content and organisational structure, it is particularly important that each user be able to tune their file system to meet their needs.

Moreover, a salient challenge in designing file system interfaces for tabletop computing is user control over privacy, as users need sufficient control over what information is released to the surface computer.

A collaborative interface should also allow people to interact privately when desired (for example, to locate specific files from an area of the file system that is potentially sensitive). These mechanisms for private access and control should be unobtrusive, so as to not hinder other users or the main task on the surface computer.

These critical issues must be addressed if a new file system interface is going to be adopted and used to its full potential for tabletop computing.

### SUMMARY OF THE INVENTION

In a first aspect, the present invention provides a method for transferring files to a pervasive computing system, comprising the steps of selecting on a computing system, via a portable computing device, at least one file to be made available to a pervasive computing system, and allowing the selected files to be transferred from a computing system to the pervasive computing system.

The portable computing device may include a software application arranged to connect with the computing system to allow the step of selecting the at least one file and the computing system may include an explorer application arranged to connect with the software application on the portable computing device to allow the step of selecting the at least one file.

At least one file may be designated a focus file. Upon selecting the focus file, the method may include the further step of selecting a sub-set of files associated with the focus file. This in turn may include the step of reviewing metadata attributes to determine the association between a plurality of files and the focus file and/or reviewing the contents of a plurality of files to determine the association between each of the plurality of files and the focus file.

The metadata attributes may be attributed a weighting, wherein the weighting is utilised to determine the association between the plurality of files and the focus file.

At least one of the files, sub-set of files and plurality of files may be displayed in one of a hierarchical and associative manner.

The method may include the initial step of scanning at least one network for a list of computing devices and/or prompting a user to connect to at least one of the computing devices located on the at least one network.

A user may exclude at least one file if it is deemed not relevant or private.

In a second aspect, the present invention provides a system for transferring files comprising a module arranged to select on a computing system, via a portable computing device, at least one file to be made available to a pervasive computing system, and a module arranged to allow the selected files to be transferred from a computing system to the pervasive computing system.

In a third aspect, the present invention provides a computer program comprising at least one instruction which, when implemented on a computer readable medium of a computer system, causes the computer system to implement the method in accordance with the first aspect of the invention.

In a fourth aspect, the present invention provides a computer readable medium providing a computer program in accordance with the third aspect of the invention.

In the context of the specification, the term “file” is intended to be construed broadly and include within its scope any block of arbitrary data that is utilisable by a computing system. Files may, for example, include multimedia files (e.g. audio files, video files, data files, etc.) or other information blocks, such as emails, instant messages, or any other self contained “piece” of data. Moreover, the files may be encoded or encrypted as required.

### DETAILED DESCRIPTION OF THE DRAWINGS

Notwithstanding any other embodiments that may fall within the scope of the present invention, an embodiment of the present invention will now be described, by way of example only, with reference to the accompanying figures, in which:

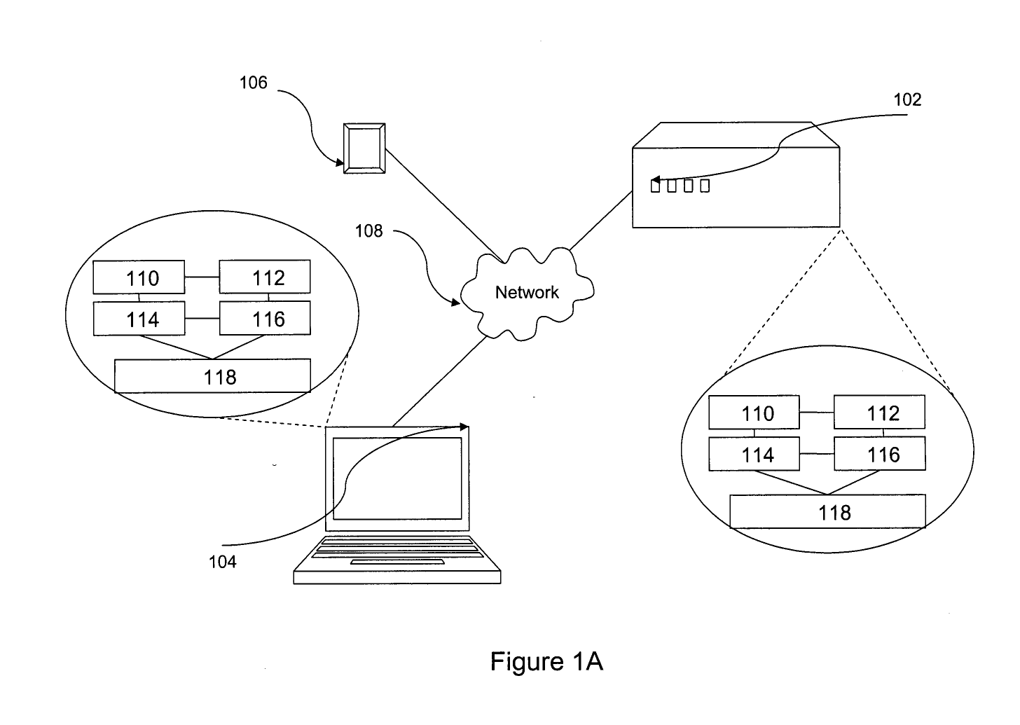

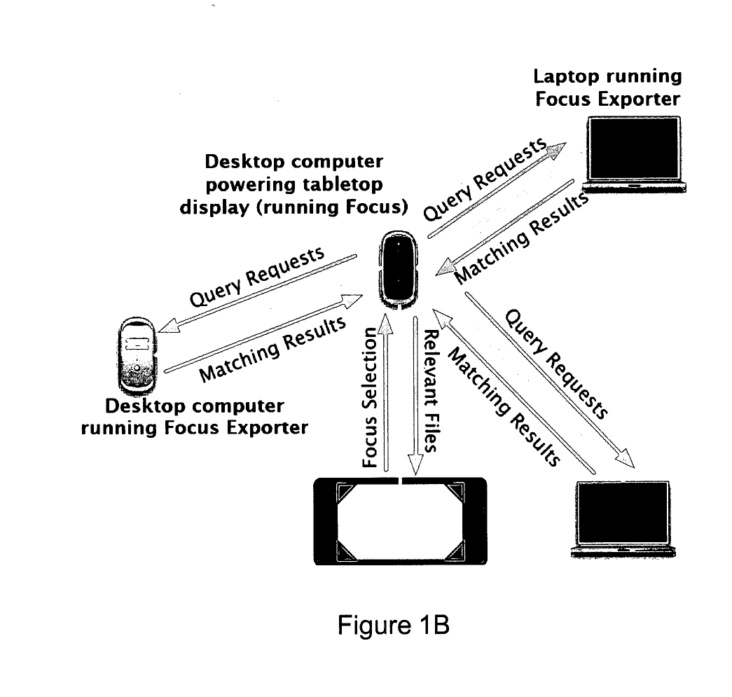

FIGS. 1a and 1b are diagrams of a system for transferring files between computing devices, in accordance with an embodiment of the present invention;

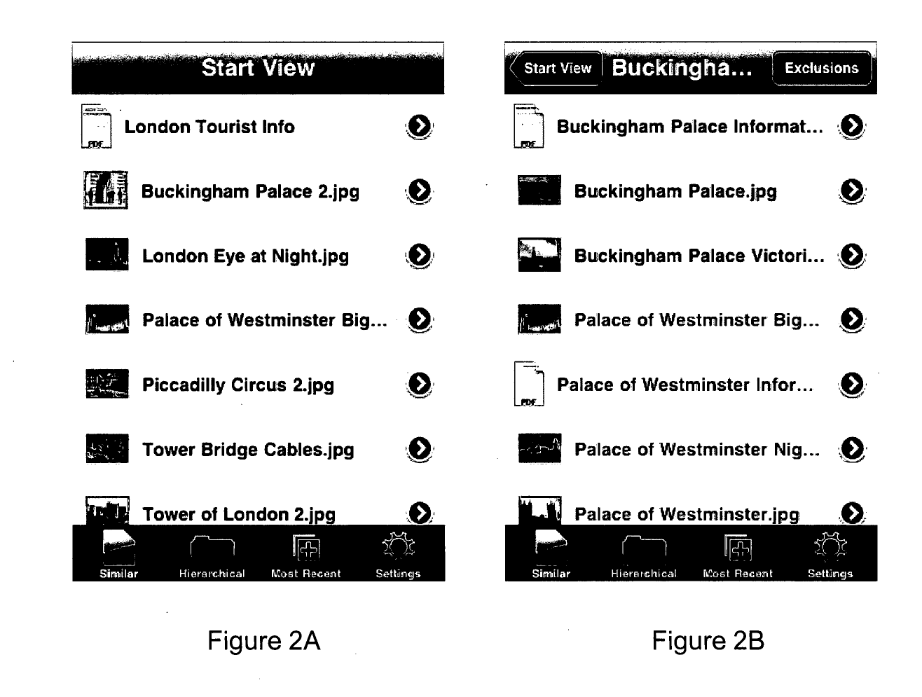

FIGS. 2a-2f are screenshots of the “Focus” software application interface in accordance with an embodiment of the present invention;

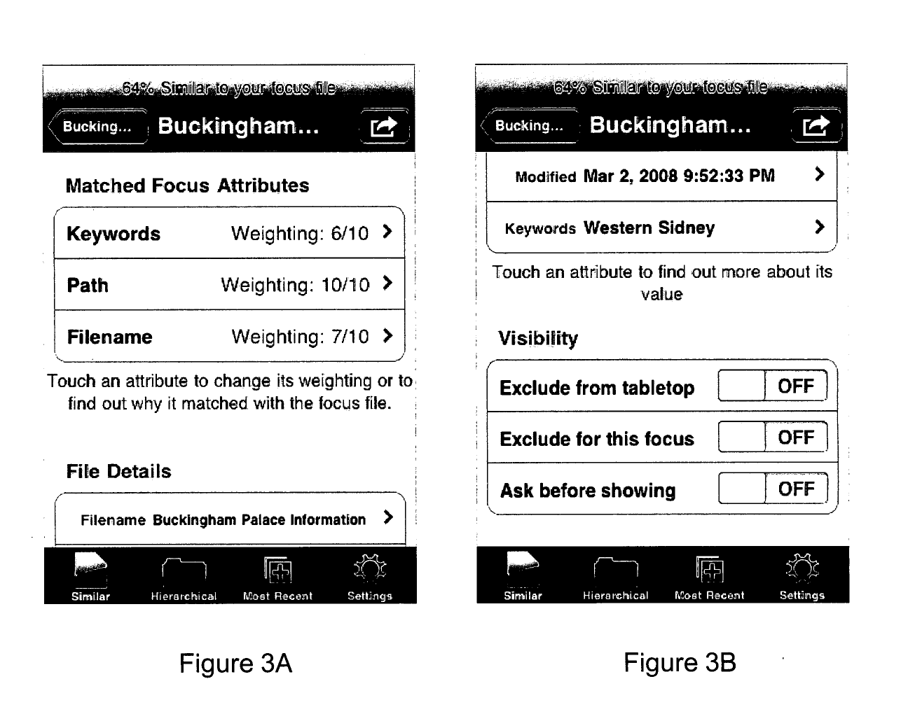

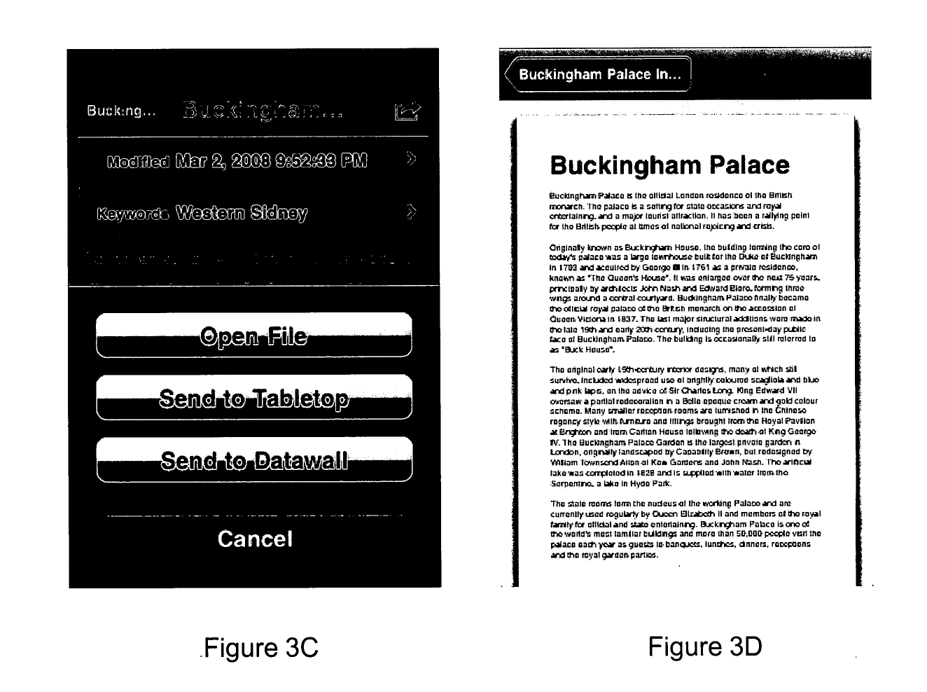

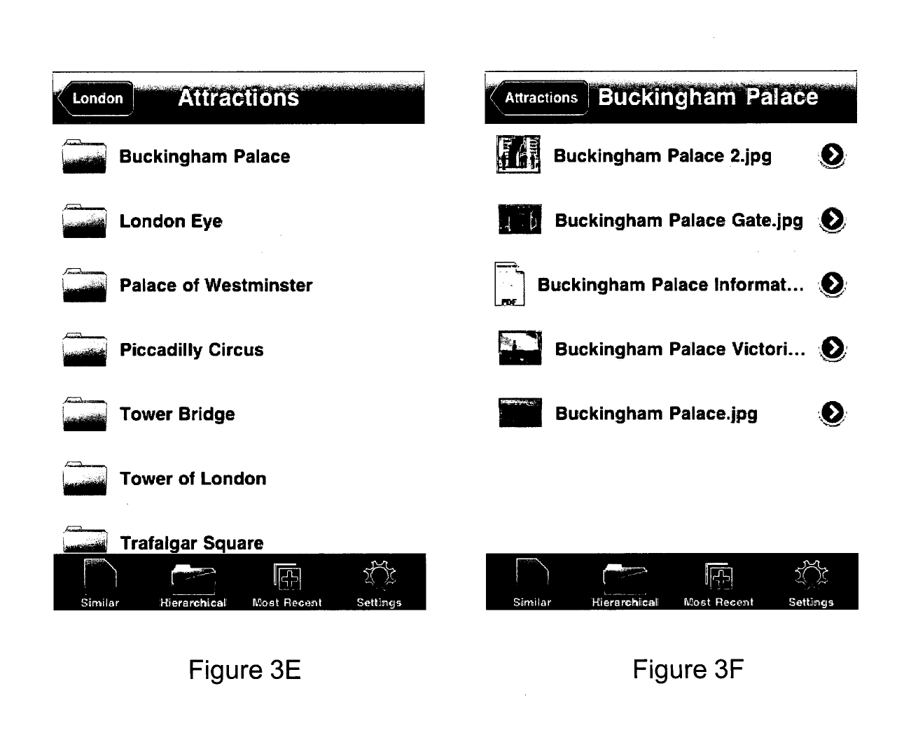

FIGS. 3a-3b are further screenshots of the “Focus” software application interface in accordance with an embodiment of the present invention; and

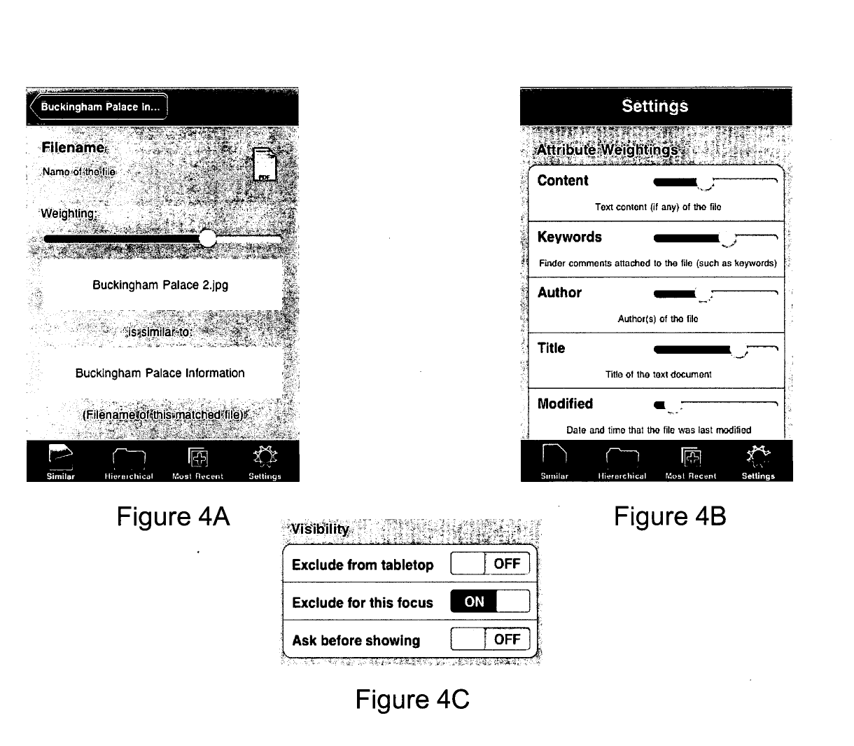

FIGS. 4a-4e are further screenshots of the “Focus” software application interface in accordance with an embodiment of the present invention; and

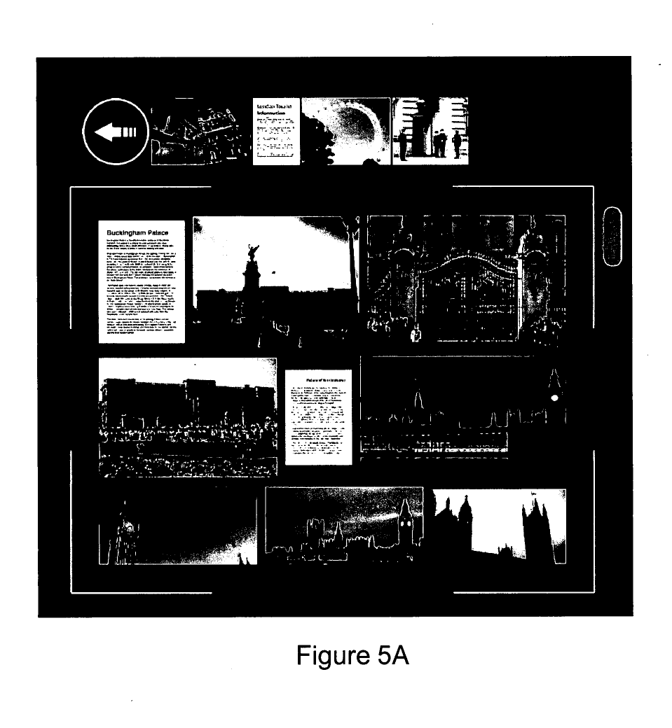

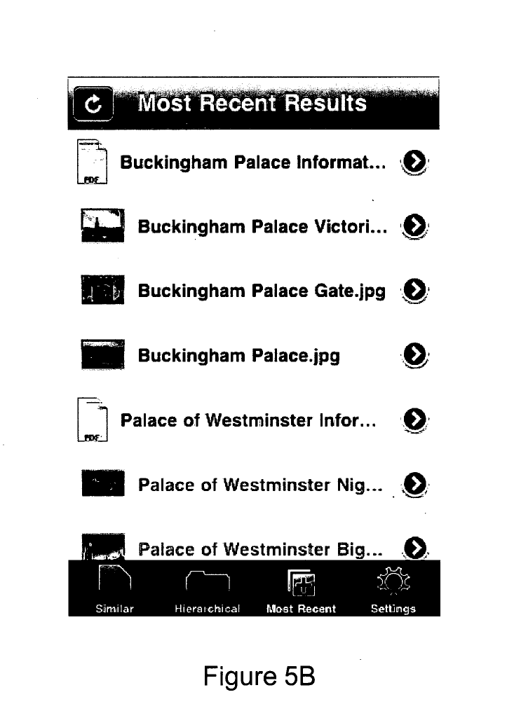

FIGS. 5a-5b are further screenshots of the “Focus” software application interface in accordance with an embodiment of the present invention.

### DESCRIPTION OF PREFERRED/SPECIFIC EMBODIMENTS

In the description which follows an embodiment of the present invention is described in the context of a system and method for transferring any type of data files, but particularly multimedia files, such as compressed video and image files, between two computers remotely connected over a communications network in the form of Local Area Network (LAN). However, it will be understood that the present invention is not limited to the example application described herein and is equally applicable for transferring any form of electronic file between any number and configuration of computing systems.

With reference to FIGS. 1a and 1b, data files are transferred between two computing devices in the form of a personal computer including a surface-mount touch screen display (hereafter “tabletop computer”) and a remote computer 102, 104, respectively. The transfer of files is facilitated via an interface provided on a third portable or handheld computing system 106, such as a mobile phone. In the embodiment described herein, the computer 104 serves as the “host” computer providing the multimedia files for transfer, while the tabletop computer serves as the “client” computer configured to receive the files. The handheld computing system 106 serves as a “control centre” for transferring the files between computers 102 and 104.

The computers 102, 104 are connected over a communications network in the form of a local or wide area network 108 and communicate using a packet-switched protocol, such as the TCP/IP protocol. The tabletop computer 102 includes a user interface provided on the surface-mount display. The user interface on handheld computing system 106 is a graphical user interface (GUI) arranged to display multimedia files stored by both the tabletop computer 102 and the computer 104. The GUI also allows a user to send commands to either tabletop computer 102 and/or computer 104 to manipulate the files and objects/icons associated therewith.

To carry out this functionality, the tabletop computer 102 comprises computer hardware including a motherboard, central processing unit 110, random access memory 112, hard disk 114 and networking hardware 116. In addition to the hardware, the tabletop computer 102 includes an operating system (such as the Linux operating system, which can be obtained from the Internet from a number of providers, such as but not limited to websites located at URLs http://www.redhat.com, http://www.suse.com and http://www.ubuntu.com) that resides on the hard disk and which co-operates with the hardware to provide an environment in which the software applications can be executed.

The tabletop computer 102 also includes a receiving module including standard software and hardware (such as a TCP/IP socket) for receiving multimedia files sent from the computer 104.

The computer 104 comprises essentially the same hardware as the tabletop computer 102 (i.e. motherboard, central processing unit, random access memory, a hard disk or other similar storage device, monitor and a user input). In addition, the hard disk of the computer 104 is loaded with an operating system (such as Microsoft Windows XP™, available from Microsoft Corporation or Apple OS X™, available from Apple Inc.) capable of interacting with the hardware of the computer 104 to provide an environment in which software applications can be executed.

Referring to FIG. 1b in particular, there is shown a system diagram illustrating the components of a system in accordance with an embodiment of the present invention. The system includes a tabletop computing system 102 which is made up of a tabletop display 102a and a computing system 102b (collectively 102), and one or more computing devices 104b, 104c (collectively 104) in communication with the tabletop computing system 102. There are also provided a number of handheld or portable devices 106a, 106b (collectively 106) which can be utilised to control computing devices 104b, 104c respectively.

FIG. 1b depicts an example computing environment in which a software application in accordance with an embodiment of the invention may operate. The environment is comprised of multiple computers, such as laptops and desktop computers that export their file system to a tabletop display computer. The computer running and powering the tabletop display is connected to each of these computers, and performs query requests whenever a file is selected for delivery to the tabletop via a mobile device.

The embodiment described herein provides an associative file access interface that, with a single interface action, retrieves similar information from each users file collection, regardless of how it is stored in the underlying file hierarchy. These on the fly associations are based on file meta-data, as well as any textual content present in the files.

The software provides flexible control to the user over which of their files are accessible from the tabletop, and how their information is calculated to be similar. It is likely that users will need to regularly control and tune these parameters while working at the tabletop, depending on the task at hand and who they are collaborating with. Users may also need to access specific files to the tabletop after checking them first. Furthermore, it is important that the user is able to understand why the associative search mechanism returned the files that it did.

In more detail, the interface is arranged to be rendered on and operated from a personal device that a user utilises as a companion while interacting at the tabletop.

The key software components in this embodiment are the associative tabletop file system interface, dubbed “Focus”, that multiple users can use to access and collaborate with their file systems; and an associated software application dubbed “Focus Inspector”, that is located on the user's personal device and is used to scrutinize, control, and allow private access to a remote file system while working with others at the tabletop.

### The “Focus” Interface

Focus is an associative file system interface that retrieves all files related to the current focus file, across each computer of the users at the tabletop. To make files accessible at the table, users run the Focus Exporter application on their personal computer. This allows them to make the whole file system, or specific parts of the file system, available for access at the tabletop computer.

When Focus is first launched a broad start view shows the first file (alphabetically) in each exported directory of each remote file system on the tabletop. From the start view, file navigation is based on the notion of a focus file. Once a user selects a focus file, all other similar files (based on file content and other meta-data) across the file systems are loaded and displayed on the tabletop. The retrieved files are presented as a single file-space, regardless of which file system they are located in, or which application they belong to (for example, relevant email is integrated with the file system). To find similar files, the Focus Exporter conducts a search on the users' exported file system and applies weightings to different meta-data attributes, thus allowing users to customise how their files are determined to be similar to others.

### The “Focus Inspector” Application

As it is common for users to carry mobile devices such as cell phones, such carried devices provide a suitable platform for private input for collocated tabletop interaction.

This allows users to perform private tasks away from the common tabletop interface, reducing clutter and potential interference with other users of the tabletop.

It also has the advantage that users can interact privately with their device, away from the other users of the table. When adjusting personal settings related to one's files, it makes sense that this can be done on a personal device, rather than a shared workspace that does not provide privacy.

The embodiment described herein utilizes the Apple iPhone™ to develop an application that allows navigation of files from remote personal machines, and that integrates this file access with the tabletop. Of course, it will be understood that other mobile phones and/or devices may be utilized, including legacy mobile phones which utilize a web browser.

A user can send specific files to be shown on the table, or they can inspect the results of associative search queries to understand and scrutinize the file access system.

### Using Focus Inspector

The following paragraphs describe how the user accesses files from the Focus Inspector application and how the user scrutinizes and controls the file access mechanism to suite both the task and the structure of their personal file system.

### Individual File Access

A key feature of Focus Inspector is that it allows a user to access their file systems. These may include the user's laptop and desktop computers, connected to the same Local Area Network (LAN) as the iPhone and tabletop. When the Focus Inspector application is first launched on the phone, a list of computers belonging to the user is presented on the screen (automatically populated using Apple's Bonjour—a multicast DNS service discovery protocol), and a user can then touch one to connect to it, prompting them for their username and password.

Once connected, the user as able to access their files using two forms of browsing: associative (being the form of navigation used on the tabletop), and hierarchical. We now illustrate these navigation modes on the mobile device.

### Associative and Hierarchical Browsing

Associative browsing, also used to locate files on the tabletop with the Focus application, allows a user to access their file collection based on content, without reliance on where information is stored in the underlying file hierarchy.

File access is based on the concept of a focus file, where a user can find similar files to the chosen focus file. For example, if the user wishes to see more files that are similar to “Buckingham Palace 2.jpg”, they can select this as the focus file (by touching it), and all files that are determined to be similar to this are then presented (as shown in FIGS. 2a and 2b). A user can go back to the previous screen of results by pressing a back button.

Similarity is determined from a number of meta-data attributes, such as modification time, tags, filename, location in the file system, as well as the text content of the file (if any). Each meta-data attribute is assigned a weighting to indicate its importance in the similarity calculation process.

This process can be controlled by the user, depending on the task and the organisation of their file system, as discussed below in more detail.

For any of the similar files listed in FIG. 2b, the user can press the detail disclosure button (a blue circle with an arrow) to be presented with more information about the file and why it is similar to the focus file. FIGS. 3c and 3d show the detailed information screen, which is made up of three sections: similar attributes, file details, and visibility.

Moreover, at FIGS. 3c and 3d, there is provided an action button at the top-right of the file detail screen can be pressed to bring up the actions menu. From the actions menu, the user can either open the file, or send it to the tabletop or the datawall (a large wall display next to the tabletop) for immediate display. Users may also access their files hierarchically when desired.

A “Hierarchical” tab at the bottom of the application allows users to the hierarchical mode, where they can navigate through the folder structure on their computer. The start view (2a) is shown when the application is first launched. A user can touch a file in the list to find any files that are ‘similar’ to it (the blue highlight shows the point of touch), and the similar files are then presented in a list of results (3f). For more information about a file, a user presses the blue “detail disclosure” circle (2b). The file information screen shows similar attributes (2c), useful metadata about the file (2c and 2d), and visibility settings (2d). The file action button can be pressed (2d and 2e) to view the file (2f) or send it to the tabletop.

FIG. 3e shows the contents of a folder. To view the contents of a folder, the user touches the folder and its contents are then presented (FIG. 3f). A user may go back to the previous level of the hierarchy by pressing the back arrow at the top left of the screen. The user may also press the detail disclosure button to see the file's meta-data or to access the actions menu (as for associative browsing).

### Scrutiny and Control Tools

As users access their files differently, depending on both personal organisation structures and the task at hand, an associative access mechanism must be understandable and adjustable.

The Focus Inspector application includes facilities to help users scrutinise the associative access mechanism, with the goal of helping users understand and better leverage the new access technique, and to equip them with the tools to tweak the retrieval mechanism if they so desire.

When a focus selection is performed and the results are returned (FIGS. 2a and 2b), a user can view the similar attributes of a file from the file information screen (FIG. 3a). This lists the attributes of the file that were matched against the selected focus file. A user can touch any of the attributes to find out more about the match. For example, FIG. 4a shows more information about the display name attribute which was matched with the display name of the focus file. The match is then used to contribute to an overall similarity score for the file (indicating how similar the file is to the selected focus file). A weighting is assigned to each meta-data attribute to affect the score. If the user wishes, they may then select the “Settings” tab, to adjust the weightings of any of the meta-data attributes supported by the system.

Referring to FIGS. 4a-4c, there is shown a number of the scrutiny and control features of the Focus Inspector application. FIG. 4a shows the information about a similar attribute (the “Display name” from FIG. 2c). The “Settings” tab can then be selected to adjust the weighting of the attribute if desired shows the results of a focus selection which has an exclusion (see FIG. 2b). Touching the “Exclusion” button brings up the exclusions list, which allows a user to view and edit the exclusions and shows an excerpt of the file information for the excluded item.

If a file is incorrectly displayed in the results—for example, if a file has a similar filename to another but they are not semantically related in any way a user can exclude it, so that the file is not presented as a similar file when the same focus is selected again. To exclude a file, a user can toggle the “Exclude for this focus” option when viewing the detailed information about the file (FIG. 4c), and an “Exclusions” button will then appear at the top of the results for the current focus file (FIG. 2b). The list of results for that focus file will not show any excluded files, but the exclusions list can still be viewed and edited by the user.

Finally, it is also important that users can view more information about any of the files presented on the tabletop after selecting a focus item on there. FIG. 5b shows the “Most Recent Results” feature, where a user can gain more information about any of the files presented on the tabletop

Referring to FIG. 5, there is shown the recent results list in the Focus Inspector application. After a focus selection is made on the tabletop (5a), the user can select the “Most Recent Results” tab of the Focus Inspector to see a list of all files on the tabletop (5b). From here, the user can view more information about a file, such as the “similar attributes” to understand why the file is similar to the focus file information about any file, exclude any files from the current focus file, or exclude any files entirely from ever being displayed on the tabletop (by marking them private).

### Implementation

Focus has been developed using the Cruiser tabletop platform, a multi-user, gestural, collaborative tabletop framework that is hardware-independent. It supports a variety of pen and touch-based hardware. Cruiser uses OpenGL to leverage the capabilities of modern graphics hardware.

Focus currently supports the tabletop display of a range of file types, including images, PDF documents, stored web pages, and email.

To make files accessible to the tabletop, users run the Focus Exporter application on any computers that they wish to enable access to. This application uses the Apple Spotlight content-based search framework for conducting queries in the file system, but applies additional measurements to determine the level of similarity between files. The tabletop running Focus, and any mobile devices running the Focus Inspector, communicate with the exported file systems on a local network over a Transport Layer Security (TLS) protected HTTPS connection. The communication protocol uses JavaScript Object Notation (JSON), making it easy to develop Focus clients on any platform (particularly web browsers with JavaScript support).

### Evaluation

The personal mobile interface, Focus Inspector, is designed to address three barriers affecting the uptake of a new class of collaborative file system interface: unfamiliarity, unpredictability, and lack of control over the retrieval process. Essentially, the goal of our evaluation was to test whether the approach was effective at helping break those barriers, as well as gain qualitative feedback to drive the design of future prototypes. We chose to evaluate our approach using an exploratory and mostly qualitative think aloud experiment.

It was hypothesised that:

H1: Users can effectively locate files on the mobile device using the same associative access mechanism used on the tabletop.
H2: Users can gain an understanding of why a particular file is returned by an associative access search, thereby gaining a better understanding of the system as a whole.
H3: Users can effectively control and fine-tune the weightings used to determine the results returned by the associative access, and easily adjust these depending on the task at hand.

Eight participants were recruited for the study (3 female and 5 male), with an age range of 21-30. This number allowed general usability issues to be highlighted, and also enabled a quantitative and qualitative analysis to test our hypotheses. The majority of participants were students, and some had used a tabletop interface before. None had used Focus or seen the Focus Inspector. Participants were given a coffee/cake voucher as compensation for their time.

### Experimental Procedure

A travel planning scenario was devised for the experiment that involved retrieving different types of information (such as email, stored web pages, textual documents and images) that would be typically stored and managed with different applications. For example, emails will typically remain in an email client, instead of being saved to a folder in the file system along with any related files. Travel planning was chosen as it would involves many types of information that would need to be accessed before travelling, such as flight bookings, hotels, destination guides, itineraries, and information about attractions to visit. The scenario told to participants was they were spending a week in London, England. They needed to access certain files to finalise their plans for the trip.

Participants were provided with a set of files to use in the experiment, and the tasks involved retrieving a subset of them (H1). Using a provided data-set allowed control over which files would be returned when conducting an associative access search, and consequently allowed the experiment to have tasks that made it more involved for participants to find what they needed. The tasks were designed such that participants would have trouble locating certain files. How the participants used the system to overcome the problem was then observed, which would involve the user gaining an understanding of why the system was presenting the results that it did (H2), and correcting this to include the missing information (H3).

The experiment began with a short background questionnaire to gain general information about the participant, including their level of experience in accessing files, and whether they have used an interactive tabletop or touch screen mobile device for accessing files. Next was a familiarization stage, where participants were required to view and organise the provided files (starting with a flat, unstructured collection and ending with a well-organised file system with X directories) using a conventional desktop computer, so that they were familiar with the files for the main tasks at the tabletop. When the participant was ready to proceed, they were asked to sit at the Focus tabletop while holding an iPhone running Focus Inspector. The experiment gave a short, interactive tutorial on how to access files with both the iPhone and the tabletop interface. For every feature that was demonstrated, the participant was asked to try it too. Participants were then given two basic tasks with each interface to make sure they were ready to proceed.

The experiment consisted of five key tasks. The first asked the participant to set the attribute weightings on the iPhone based on their knowledge of the file collection they organised. They were then asked to locate specific information about various tourist attractions, hotels, and travel booking emails. At each stage the participant was asked to explain to the experiment why the results were presented to them (i.e. which meta-data attributes matched for the focus file they selected). The first two main access tasks involved locating information privately just with the iPhone, and then sending specific information to the tabletop. The second two access tasks involved accessing files from the tabletop and then changing the weightings on the iPhone as required.

### Hardware and Data Collection

The experiment was conducted in a lab environment that consisted of a pen-based interactive tabletop, using the Mimio Interactive whiteboard capture system in conjunction with a top-projected display on a white table.

An iPhone was also provided for participants to use during the experiment. The experiment was audio and video recorded and all computer and phone actions were logged for quantitative analysis.

### Results

After completing the tasks, participants were asked to complete a questionnaire—made up of Likert-scale and freeform questions—that gained feedback on general usability and how well the participant understood how the retrieval system worked during and after completing the tasks.

They were asked whether they understood how the retrieval system worked, and understood how to control it to change the information retrieved for each search. The data was processed by noting interesting features of interaction from the video recordings, and analysed in conjunction with the pre and post-experiment questionnaires results. The post-experiment questionnaire gathered a large amount of feedback, and quantitative results regarding a user's understanding of the associative access mechanism.

The results are summarized in the Likert Table (Table 1) shown below, where the numeral “7” is the highest value available, indicating the strongest agreement.

TABLE 1
Likert Scale for Focus Software Application

| Question | Mean | Mode |
|---|---|---|
| I was able to easily find all the | 5.8 | 6 |
| files I needed in the tasks where I | | |
| was asked to use the iPhone | | |
| interface. | | |
| I was able to easily find all the | 6 | 5 |
| files I needed in the tasks where I | | |
| was asked to use the tabletop | | |
| interface. | | |
| It was clear why [a file] was related | 6.6 | 7 |
| to the current focus file (i.e. I | | |
| could see which meta-data attributes | | |
| matched) | | |
| I understood how to change the | 6.8 | 7 |
| similarity mechanism when I was | | |
| required to. | | |
| I knew which changes I should make to | 6.3 | 6 |
| improve the similarity mechanism when | | |
| I was asked to do so. | | |
| The changes I made to the similarity | 6.4 | 7 |
| mechanism made it easier to find the | | |
| required files. | | |
| Overall, I was able to understand how | 6.6 | 6 |
| the system and the similarity | | |
| mechanism works. | | |
| After completing the tasks I feel | 6.5 | 6 |
| confident in using such a system to | | |
| locate files at the tabletop. | | |

### Alterations and Modifications to the Embodiments

It will be understood that further services may be added to the embodiments described herein without departing from the broader invention which is disclosed herein. For example, the software application may also be arranged to interact with other software applications on a tabletop or other surface computing environment. Embodiments may also find application in conventional computing devices. Such variations and modifications are within the purview of a person skilled in the art.

In the preceding embodiments, reference has been made to at least two software applications, namely “Focus” and “Focus Inspector”. It will be understood that the software applications may be written in any appropriate computer language, and arranged to execute on any suitable computing hardware, in any configuration. The software application may be a stand alone software application arranged to operate on a personal or server computer, or a portable device such as laptop computer, or a wireless device, such as a tablet PC or a PDA (personal digital assistant).

The software application may alternatively be an application arranged to operate on a central server or servers. The application may be accessed from any suitable remote terminal, through a public or private network, such as the Internet.

Where the software application interfaces with another computing system or a database, the data may be communicated via any suitable communication network, including the Internet, a proprietary network (e.g. a private connection between different offices of an organisation), a wireless network, such as an 802.11 standard network, or a telecommunications network (including but not limited to a telephone line, a GSM, CDMA, EDGE or 3G mobile telecommunications network, or a microwave link).

It will also be understood that the embodiments described may be implemented via or as an application programming interface (API), for use by a developer, or may be implemented as code within another software application. Generally, as software applications include routines, programs, objects, components, and data files that perform or assist in the performance of particular functions, it will be understood that a software application may be distributed across a number of routines, objects and components, but achieve the same functionality as the embodiment and the broader invention claimed herein. Such variations and modifications would be within the purview of those skilled in the art.

The foregoing description of the exemplary embodiments is provided to enable any person skilled in the art to make or use the present invention. While the invention has been described with respect to particular illustrated embodiments, various modifications to these embodiments will be readily apparent to those skilled in the art, and the generic principles defined herein may be applied to other embodiments without departing from the spirit or scope of the invention.

The present embodiments are, therefore, to be considered in all respects as illustrative and not restrictive.

1. A method for transferring files to a pervasive computing system, comprising the steps of selecting on a computing system, via a portable computing device, at least one file to be made available to a pervasive computing system, and allowing the selected files to be transferred from a computing system to the pervasive computing system.

2. A method in accordance with claim 1, wherein the portable computing device includes a software application arranged to connect with the computing system to allow the step of selecting the at least one file.

3. A method in accordance with claim 2, wherein the computing system includes an explorer application arranged to connect with the software application on the portable computing device to allow the step of selecting the at least one file.

4. A method in accordance with claim 1, wherein the at least one file is a focus file.

5. A method in accordance with claim 4, wherein, upon selecting the focus file, the method includes the further step of selecting a sub-set of files associated with the focus file.

6. A method in accordance with claim 5, wherein the step of selecting further includes the step of reviewing metadata attributes to determine the association between a plurality of files and the focus file.

7. A method in accordance with claim 5, wherein the step of selecting further includes the step of reviewing the contents of a plurality of files to determine the association between each of the plurality of files and the focus file.

8. A method in accordance with claim 6, wherein the metadata attributes are attributed a weighting.

9. A method in accordance with claim 8, wherein the weighting is utilised to determine the association between the plurality of files and the focus file.

10. A method in accordance with claim 1, wherein at least one of the files, sub-set of files and plurality of files are displayed in one of a hierarchical and associative manner.

11. A method in accordance with claim 1, comprising the initial step of scanning at least one network for a list of computing devices.

12. A method in accordance with claim 11, comprising the further step of prompting a user to connect to at least one of the computing devices located on the at least one network.

13. A method in accordance with claim 5, comprising the further step of allowing a user to exclude at least one file.

14. A system for transferring files comprising a module arranged to select on a computing system, via a portable computing device, at least one file to be made available to a pervasive computing system, and a module arranged to allow the selected files to be transferred from a computing system to the pervasive computing system.

15. A system in accordance with claim 14, wherein the portable computing device includes a software application arranged to connect with the computing system to allow the step of selecting the at least one file.

16. A system in accordance with claim 15, wherein the computing system includes an explorer application arranged to connect with the software application on the portable computing device to allow the step of selecting the at least one file.

17. A system in accordance with claim 14, wherein the at least one file is a focus file.

18. A system in accordance with claim 17, wherein, upon selecting the focus file, the method includes the further step of selecting a sub-set of files associated with the focus file.

19. A system in accordance with claim 18, wherein selecting further includes reviewing metadata attributes to determine the association between a plurality of files and the focus file.

20. A system in accordance with claim 18, wherein selecting further includes reviewing the contents of a plurality of files to determine the association between each of the plurality of files and the focus file.

21. A system in accordance with claim 19, wherein the metadata attributes are attributed a weighting.

22. A system in accordance with claim 21, wherein the weighting is utilised to determine the association between the plurality of files and the focus file.

23. A system in accordance with claim 14, wherein at least one of the files, sub-set of files and plurality of files are displayed in one of a hierarchical and associative manner.

24. A system in accordance with claim 14, comprising the initial step of scanning at least one network for a list of computing devices.

25. A system in accordance with claim 24, comprising the further step of prompting a user to connect to at least one of the computing devices located on the at least one network.

26. A system in accordance with claim 18, comprising the further step of allowing a user to exclude at least one file.

27. A computer program comprising at least one instruction which, when implemented on a computer readable medium of a computer system, causes the computer system to implement the method in accordance with claim 1.

28. A computer readable medium providing a computer program in accordance with claim 27.
